(19) United States
(12) Patent Application Publication
(10) Pub. No.: US 2022/0225243 A1
(43) Pub. Date: Jul. 14, 2022

(54) FIRST AND SECOND COMMUNICATION DEVICES FOR POWER CONTROL IN GROUPCAST COMMUNICATION

(71) Applicant: Huawei Technologies Co., Ltd., Shenzhen (CN)

(72) Inventors: Gustaf CLAESON, Kista (SE); Taimoor ABBAS, Kista (SE); Bengt LINDOFF, Kista (SE)

(21) Appl. No.: 17/712,887

(22) Filed: Apr. 4, 2022

Related U.S. Application Data
(63) Continuation of application No. PCT/EP2019/076672, filed on Oct. 2, 2019.

(51) Int. Cl. H04W 52/24; H04W 4/06; H04W 52/32

(52) U.S. Cl. CPC H04W 52/242; H04W 52/327; H04W 4/06

(57) ABSTRACT

The invention relates to power control in groupcast communication between a first communication device (100) and a set of second communication devices (300a, 300b, . . . , 300n). The first communication device (100) obtains received signal qualities from a reporting subset (300a′, 300b′, . . . , 300n′) in the set of second communication devices (300a, 300b, . . . , 300n) and determines at least one path loss value for the reporting subset (300a′, 300b′, . . . , 300n′) based on the one or more obtained received signal qualities. The first communication device (100) may further determine a transmission power value for the groupcast communication based on the at least one path loss value and perform a groupcast communication transmission based on the determined transmission power value. Furthermore, the invention also relates to a second communication device (300), corresponding methods, and a computer program.

### CROSS-REFERENCE TO RELATED APPLICATIONS

This application is a continuation of International Application No. PCT/EP2019/076672, filed on Oct. 2, 2019, the disclosure of which is hereby incorporated by reference in its entirety.

### TECHNICAL FIELD

The invention relates to a first communication device and a second communication device for power control in groupcast communication. Furthermore, the invention also relates to corresponding methods, and a computer program.

### BACKGROUND

Vehicle-to-anything (V2X) communications, is one of the key enablers for future cooperative intelligent transportation systems (C-ITS). The term V2X jointly represents vehicles communicating with anything on the road or along the road.

A new interface named PC5 or sidelink was introduced in long term evolution (LTE) that supports direct communication in the 5.9 GHz band. Sidelink is specifically designed to meet the requirements for advanced safety applications. Compared to LTE, which supports broadcast and unicast mode communication, new radio (NR) sidelink shall in addition support groupcast communication.

Groupcast communication is simultaneous data transmission to a group of user equipments (UEs). In groupcast communication there is at least one source or transmitter UE and multiple destination or receiver UEs.

For groupcast there exist different scenarios, with examples such as Intersection movement assistance and Platooning. Further in some cases it is important that all UEs within the group can be reached with the groupcast transmission while in other cases only a certain range from the source UE is of importance and outside the range the transmission is best effort.

### SUMMARY

An objective of embodiments of the invention is to provide a solution which mitigates or solves the drawbacks and problems of conventional solutions.

The above and further objectives are solved by the subject matter of the independent claims. Further advantageous embodiments of the invention can be found in the dependent claims.

According to a first aspect of the invention, the above mentioned and other objectives are achieved with a first communication device for a wireless communication system, the first communication device being configured for groupcast communication with a set of second communication devices, and further being configured to

obtain one or more received signal qualities from respective one or more second communication devices of a reporting subset in the set of second communication devices;

determine at least one path loss value for the reporting subset based on the one or more obtained received signal qualities.

The groupcast communication can in this embodiment e.g. be NR groupcast communication over sidelinks between the first communication device and the set of second communication devices.

The reporting subset can be smaller than the set of second communication devices, i.e. the reporting subset can comprise fewer second communication devices than the set of second communication devices.

An advantage of the first communication device according to the first aspect is that only a subset of the second communication devices reports their received signal qualities to the first communication device. Signaling overhead can hence be reduced which reduces required scheduling resources and decreases interference. Furthermore, the reporting subset allows the reported received signal qualities to be limited to only received signal qualities from relevant second communication devices.

In an implementation form of a first communication device according to the first aspect, the reporting subset is determined based on a configuration received from a network access node or a road side unit.

The received configuration may be based on a spatial distance between the first communication device and a second communication device in the reporting subset and a required transmission range. The received configuration may further be based on a groupcast use case for the groupcast communication and/or a relative position within the group.

An advantage with this implementation form is that the network access node or the road side unit can configure the reporting subset in the groupcast communication. Thereby, optimizing system capacity and/or system performance.

In an implementation form of a first communication device according to the first aspect, the reporting subset is determined based on one or more received signal qualities received during a time window.

An advantage with this implementation form is that the reporting subset in the first communication device can be defined without prior configuration signaling. Thereby, reducing overhead signaling in the system.

In an implementation form of a first communication device according to the first aspect, the first communication device is further configured to determine a transmission power value for the groupcast communication based on the at least one path loss value.

An advantage with this implementation form is that optimized transmission power can be used for the groupcast transmission. Thereby, reducing overall system interference.

In an implementation form of a first communication device according to the first aspect, the first communication device is further configured to

perform a groupcast communication transmission based on the determined transmission power value.

An advantage with this implementation form is that optimized transmission power can be used for the groupcast transmission. Thereby, reducing overall system interference.

In an implementation form of a first communication device according to the first aspect, the first communication device is further configured to

perform the groupcast communication transmission in a physical sidelink control channel or in a physical sidelink shared channel.

The physical sidelink control channel and the physical sidelink shared channel may be channels according to the 3GPP 5G-NR standard.

An advantage with this implementation form is that transmission is performed in defined channels reducing the implementation complexity.

In an implementation form of a first communication device according to the first aspect, the first communication device is further configured to

determine a single common path loss value for the reporting subset based on a first function and the received signal qualities; and

determine the transmission power value based on the single common path loss value.

An advantage with this implementation form is that the transmission power value can be derived in a well-defined way, improving the robustness and reliability of the system.

In an implementation form of a first communication device according to the first aspect, the first communication device is further configured to

determine a path loss value for each second communication device in the reporting subset; and

determine the transmission power value based on a second function and the path loss values for each second communication device in the reporting subset.

An advantage with this implementation form is that the transmission power value can be derived in a well-defined way, improving the robustness and reliability of the system.

In an implementation form of a first communication device according to the first aspect,

the first function is the mean, weighted mean, median, minimum or maximum of the received signal qualities for the reporting subset, and

the second function is the mean, weighted mean, median, minimum or maximum of the path loss values for each second communication device in the reporting subset.

An advantage with this implementation form is that the transmission power value can be derived in a well-defined way, improving the robustness and reliability of the system.

In an implementation form of a first communication device according to the first aspect, the first communication device is further configured to

to define the reporting subset per beam, per beam pair link, or per QCL configuration.

An advantage with this implementation form is that the same procedure can be used also when the first communication device performs beam transmission, implying same implementation can be reused in the first communication device. Thereby, reducing implementation complexity.

In an implementation form of a first communication device according to the first aspect, the first communication device is further configured to

determine the reporting subset based on a spatial distance between the first communication device and a second communication device in the reporting subset and a required transmission range.

An advantage with this implementation form is that the first communication device itself can define the reporting subset. Thereby, reducing overall signaling in the network. Furthermore, by determining the reporting subset based on the spatial distance and the required transmission range, the first communication device can limit the reporting subset to only include relevant second communication devices, e.g. second communication devices close to the required transmission range. Thereby, allowing the first communication device to determine a path loss value which is relevant for the specific required transmission range.

In an implementation form of a first communication device according to the first aspect, the first communication device is further configured to

determine the reporting subset further based on a groupcast use case for the reporting subset.

An advantage with this implementation form is that the first communication device itself can define the reporting subset. Thereby, reducing overall signaling in the network.

In an implementation form of a first communication device according to the first aspect, the first communication device is further configured to

transmit a measurement configuration for the groupcast communication to at least one second communication device, wherein the measurement configuration indicates at least one reporting condition.

An advantage with this implementation form is that the first communication device can configure the second communication device, so that the reporting subset can be different. Thereby, reducing overall report signaling in the system.

In an implementation form of a first communication device according to the first aspect, the received signal quality is at least one of:

a reference signal received power,

a signal-to-noise ratio, and

a reference signal received quality.

An advantage with this implementation form is that the received signal quality is well-defined, making the system more reliable and robust.

According to a second aspect of the invention, the above mentioned and other objectives are achieved with a second communication device for a wireless communication system, the second communication device being configured for groupcast communication with a first communication device, and further being configured to

obtain a measurement configuration for the groupcast communication, wherein the measurement configuration indicates at least one reporting condition;

measure received signal quality according to the measurement configuration; and

transmit the measured received signal quality to the first communication device upon determine that the at least one reporting condition is fulfilled.

An advantage of the second communication device according to the second aspect is that that the second communication device only reports its received signal quality if the reporting condition is fulfilled. Signaling overhead can hence be reduced which reduces required scheduling resources and decreases interference.

In an implementation form of a second communication device according to the second aspect, determine that the reporting condition is fulfilled comprises

determine that the at least one reporting condition is fulfilled if a spatial distance between the first communication device and the second communication device is within a required transmission range.

An advantage with this implementation form is that the reporting condition is using relevant metrics for minimizing the signaling in the system.

In an implementation form of a second communication device according to the second aspect, determine that the at least one reporting condition is fulfilled further comprises

determine that a groupcast use case for the second communication device is fulfilled.

An advantage with this implementation form is that the reporting condition is using relevant metrics for minimizing the signaling in the system.

In an implementation form of a second communication device according to the second aspect, the second communication device is further configured to

obtain the measurement configuration from the first communication device, a network access node or a road side unit.

An advantage with this implementation form is that the first communication device, the network access node, or the road side unit can configure the reporting condition. Thereby, optimizing system capacity and/or system performance.

In an implementation form of a second communication device according to the second aspect, the received signal quality is at least one of:

a reference signal received power,

a signal-to-noise ratio, and

a reference signal received quality.

An advantage with this implementation form is that the received signal quality is well-defined, making the system more reliable and robust.

In an implementation form of a second communication device according to the second aspect, the second communication device is further configured to

transmit the measured received signal quality in layer 1 physical control signaling or in layer 3 radio resource control signaling.

An advantage with this implementation form is that the control signaling is well-defined, making the system more reliable and robust.

According to a third aspect of the invention, the above mentioned and other objectives are achieved with a method for a first communication device configured for groupcast communication with a set of second communication devices, the method comprises

obtaining one or more received signal qualities from respective one or more second communication devices of a reporting subset in the set of second communication devices;

determining at least one path loss value for the reporting subset based on the one or more obtained received signal qualities.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device configured for groupcast communication with a first communication device, the method comprises

obtaining a measurement configuration for the groupcast communication, wherein the measurement configuration indicates at least one reporting condition;

measuring received signal quality according to the measurement configuration; and

transmitting the measured received signal quality to the first communication device upon determine that the at least one reporting condition is fulfilled.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

The invention also relates to a computer program, characterized in program code, which when run by at least one processor causes said at least one processor to execute any method according to embodiments of the invention. Further, the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a method for a first communication device according to an embodiment of the invention;

FIG. 3 shows a second communication device according to an embodiment of the invention;

FIG. 4 shows a method for a second communication device according to an embodiment of the invention;

FIG. 5 shows a wireless communication system according to an embodiment of the invention;

FIG. 6 shows a method according to an embodiment of the invention;

FIG. 7 shows a method according to an embodiment of the invention; and

FIGS. 8a-d show reporting subsets in different group cast scenarios according to embodiments of the invention.

### DETAILED DESCRIPTION

In 3GPP RAN1 Rel-16 the work has started to define the sidelink power control procedure, where the main focus has been on the open loop power control procedures. For physical uplink shared channel (PUSCH) transmissions over the Uu interface, one of the components in the power calculation formula is path loss.

For the sidelink power control two different variants of path loss will be considered. The path loss between next generation node B (gNB) and source UE, i.e. downlink path loss, and the path loss between source UE and destination UE, i.e. sidelink path loss. The motivation to include downlink path loss is to mitigate interference to uplink reception at the gNB in the licensed bands, as a sidelink can utilize both licensed and unlicensed bands. Thus, limiting the interference to uplink transmission can be controlled at the gNB.

In the procedure for supporting unicast sidelink transmission it is agreed to report sidelink received signal quality to the source UE to derive the path loss. The power control procedure for sidelink groupcast has not yet been standardized. For open-loop power control for sidelink groupcast communication different proposals exist. According to one proposal the reference signal received power (RSRP) is reported by all the destination UEs and the source UE uses the one with the lowest RSRP. This solution has the disadvantage of signaling overhead of all the group members, which requires high amount of scheduling resources and further increase the interference.

Another proposal is to not use sidelink path loss between source UE and destination UE in case of groupcast. The motivation being that reporting cause a large signaling overhead. This solution has the obvious drawback that power is not regulated at all for the dynamic sidelink path loss component of the group members.

In another proposal, an RSRP threshold would be configured and when the RSRP is below the RSRP threshold, reporting of RSRP would be triggered. A disadvantage with this solution is that information above the RSRP threshold cannot be utilized and the power would be set unnecessary high. Furthermore, if the threshold is set high to not lose a large range above the threshold, then the threshold would not fully serve its purpose of limiting the amount of reporting.

In addition, the above mentioned proposals do not consider the case when only a specific communication range from the source UE is prioritized and hence it is not suitable to use the destination UE with lowest RSRP which may be outside the communication range.

Consequently, there is a need for solution which address all the above mentioned drawbacks. The objective of the invention is therefore to provide a solution that allows sidelink path loss to be considered in power control procedures with a limited signaling overhead and further in combination with a relevant transmission range target.

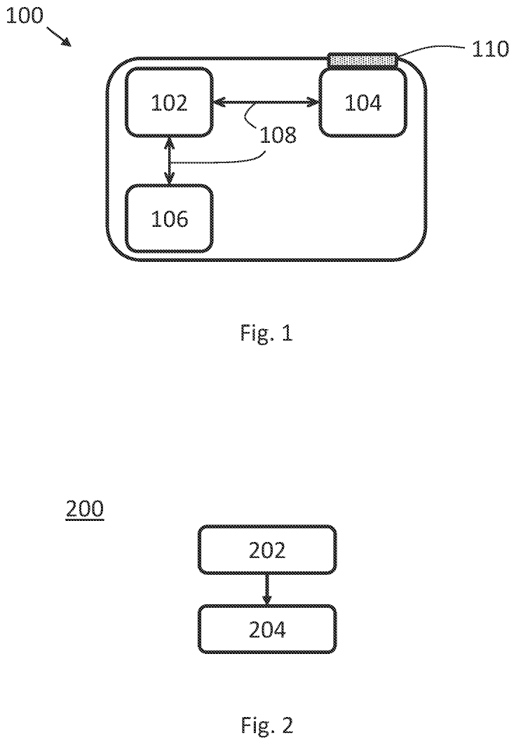

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 further comprises an antenna or antenna array 110 coupled to the transceiver 104, which means that the first communication device 100 is configured for wireless communications in a wireless communication system.

That the first communication device 100 is configured to perform certain actions can in this disclosure be understood to mean that the first communication device 100 comprises suitable means, such as e.g. the processor 102 and the transceiver 104, configured to perform said actions.

According to embodiments of the invention the first communication device 100 is configured for groupcast communication with a set of second communication devices 300a, 300b, . . . , 300n and further configured to obtain one or more received signal qualities from respective one or more second communication devices of a reporting subset 300a′, 300b′, . . . , 300n′ in the set of second communication devices 300a, 300b, . . . , 300n. The first communication device 100 is further configured to determine at least one path loss value for the reporting subset 300a′, 300b′, . . . , 300n′ based on the one or more obtained received signal qualities.

FIG. 2 shows a flow chart of a corresponding method 200 which may be executed in a first communication device 100, such as the one shown in FIG. 1, configured for groupcast communication with a set of second communication devices 300a, 300b, . . . , 300n. The method 200 comprises obtaining 202 one or more received signal qualities from respective one or more second communication devices of a reporting subset 300a′, 300b′, . . . , 300n′ in the set of second communication devices 300a, 300b, . . . , 300n. The method 200 further comprises determining 204 at least one path loss value for the reporting subset 300a′, 300b′, . . . , 300n′ based on the one or more obtained received signal qualities.

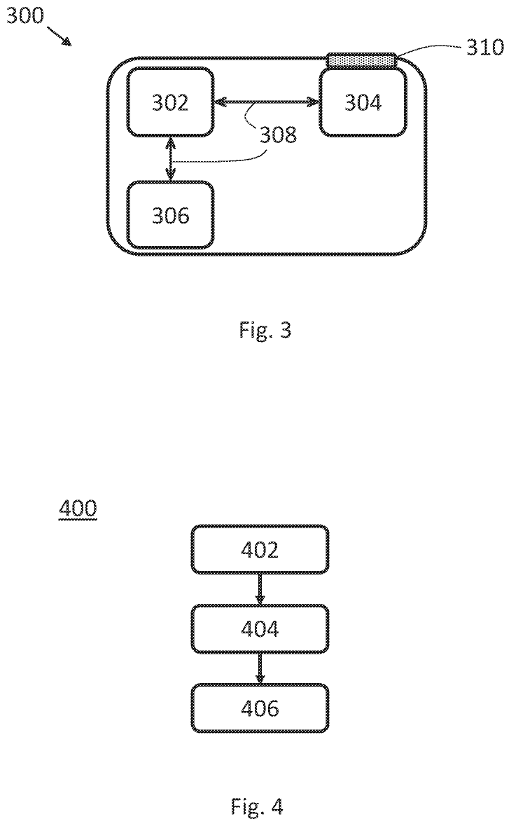

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a wireless communication system.

That the second communication device 300 is configured to perform certain actions can in this disclosure be understood to mean that the second communication device 300 comprises suitable means, such as e.g. the processor 302 and the transceiver 304, configured to perform said actions.

According to embodiments of the invention the second communication device 300 is configured for groupcast communication with a first communication device 100, and further configured to obtain a measurement configuration 520 for the groupcast communication. The measurement configuration 520 indicates at least one reporting condition. The second communication device 300 is further configured to measure received signal quality according to the measurement configuration and transmit the measured received signal quality to the first communication device 100 upon determine that the reporting condition is fulfilled.

FIG. 4 shows a flow chart of a corresponding method 400 which may be executed in a second communication device 300, such as the one shown in FIG. 3, configured for groupcast communication with a first communication device 100. The method 400 comprises obtaining 402 a measurement configuration 520 for the groupcast communication. The measurement configuration 520 indicates at least one reporting condition. The method 400 further comprises measuring 404 received signal quality according to the measurement configuration and transmitting 406 the measured received signal quality to the first communication device 100 upon determine that the reporting condition is fulfilled.

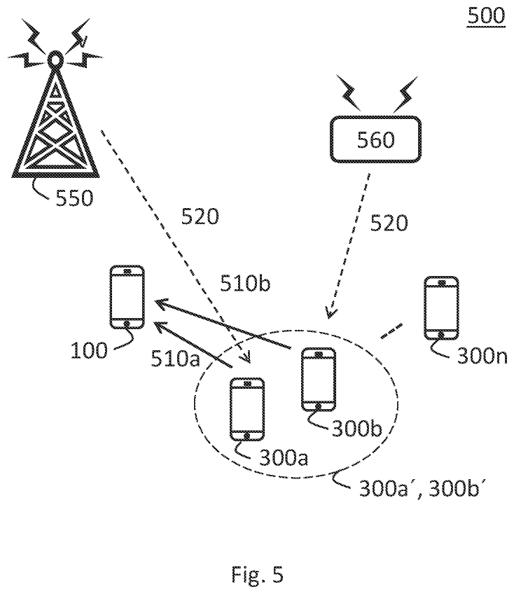

FIG. 5 shows a wireless communication system 500 according to an embodiment of the invention. The wireless communication system 500 comprises a first communication device 100 and a set of second communication devices 300a, 300b, . . . , 300n, all configured to operate in the wireless communication system 500. In the embodiment shown in FIG. 5, the first communication device 100 and the set of second communication devices 300a, 300b, . . . , 300n are all client devices such as UEs. However, one or more of the first communication device 100 and the set of second communication devices 300a, 300b, . . . , 300n may in embodiments instead be network access nodes or road side units. The first communication device 100 is configured for groupcast communication with the set of second communication devices 300a, 300b, . . . , 300n, e.g. over sidelinks (not shown in FIG. 5). In FIG. 5 it is assumed that the first communication device 100 is a source communication device of a groupcast communication and the set of first communication devices 100a, 100b, . . . , 100n are destination communication devices.

The wireless communication system 500 may further comprise one or more network access nodes and/or one or more road site units, with which one or more of the first communication device 100 and the set of second communication devices 300a, 300b, . . . , 300n may communicate. In the embodiment shown in FIG. 5, the wireless communication system 500 comprises one network access node 550 and one road side unit 560. The network access node 550 may be any type of base station such as e.g. a gNB in a radio access network (RAN). The road side unit 560 may be any device/node deployed along roads to improve vehicular network performance, as well as extend the coverage. The road side unit 560 may be a stand-alone device/node or may be integrated with e.g. a network access node.

According to embodiments of the invention a reporting subset 300a′, 300b′, . . . , 300n′ is determined from the set of second communication devices 300a, 300b, . . . , 300n, i.e. one or more of the second communication devices in the set of second communication devices 300a, 300b, . . . , 300n is determined to be included in the reporting subset 300a′, 300b′, . . . , 300n′. The number of second communication devices in the reporting subset 300a′, 300b′, . . . , 300n′ is smaller than the number of second communication devices in the set of second communication devices 300a, 300b, . . . , 300n. The second communication devices in the reporting subset 300a′, 300b′, . . . , 300n′ are configured to provide received signal quality to the first communication device 100. The configuration to provide received signal quality may be provided to the second communication devices in a measurement configuration 520 from the first communication device 100, the network access node 550 or the road side unit 560. FIG. 5 shows a non-limiting example of the optional transmission of measurement configurations 520 to one or more of the second communication devices 300.

Based on the one or more received signal qualities obtained from the reporting subset 300a′, 300b′, . . . , 300n′, the first communication device 100 may determine a transmission power value to use for a groupcast communication to the set of second communication devices 300a, 300b, . . . , 300n. In the embodiment shown in FIG. 5, two second communication devices 300a, 300b in the set of second communication devices 300a, 300b, . . . , 300n are determined to be the reporting subset 300a′, 300b′. Hence, the first communication device 100 obtains two received signal qualities 510a, 510b from the reporting subset 300a′, 300b′. One received signal quality 510a indicating the received signal quality for one second communication device 300a and the other received signal quality 510b indicating the received signal quality for the other second communication device 300b. Based on the obtained received signal qualities 510a, 510b, the first communication device 100 determines a path loss value which in turn may be used to determine a transmission power value for the groupcast communication. When the first communication device 100 performs the groupcast communication transmission to the set of second communication devices 300a, 300b, . . . , 300n, the first communication device 100 uses the determined transmission power value for the groupcast communication transmission.

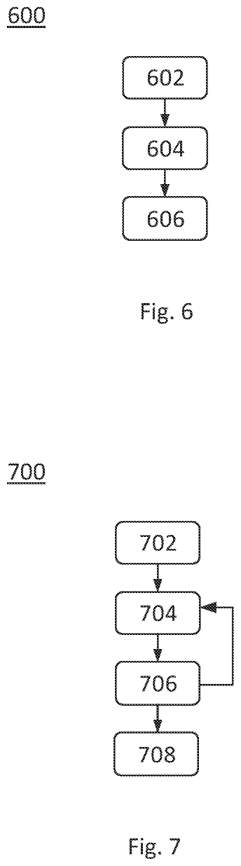

FIG. 6 shows a flow chart of a method 600 for determining a transmission power value for a groupcast communication according to embodiments of the invention. The method 600 may be performed in the first communication device 100 when configured for groupcast communication with the set of second communication devices 300a, 300b, . . . , 300n.

In step 602, the first communication device 100 obtains one or more received signal qualities from respective one or more second communication devices of a reporting subset 300a′, 300b′, . . . , 300n′ in the set of second communication devices 300a, 300b, . . . , 300n. The one or more received signal qualities obtained in step 602 may in embodiments be obtained in response to a measurement configuration 520 transmitted from the first communication device 100 to one or more of the second communication device 300. In such embodiments, the first communication device 100 has hence transmitted a measurement configuration 520 for the groupcast communication to at least one second communication device 300. The measurement configuration 520 may indicate at least one reporting condition based on which the second communication device 300 may determine whether to transmit a received signal quality or not.

The received signal quality may be at least one of a reference signal received power (RSRP), a signal-to-noise ratio (SNR), and a reference signal received quality (RSRQ). The obtained received signal qualities may further be filtered or unfiltered. When the obtained received signal qualities are unfiltered values, the first communication device 100 may use the unfiltered values or perform filtering of the unfiltered values. The filtering may e.g. comprise layer 3 filtering of reported unfiltered layer 1 RSRP values from a second communication device 300. The second communication devices in the reporting subset 300a′, 300b, . . . , 300n′ may determine the received signal quality in a conventional way based on e.g. measurement of reference signals received from the first communication device 100.

The reporting subset 300a′, 300b′, . . . , 300n′ may be determined by at least one of the first communication device 100, a network access node 550, and a road side unit 560. The network access node 550 and the road side unit 560 may be serving one or more of the first communication device 100 and the set of second communication devices 300a, 300b, . . . , 300n. The determined reporting subset 300a′, 300b′, . . . , 300n′ may be an initial reporting subset 300a′, 300b′, . . . , 300n′ which may be updated and/or reconfigured by the first communication device 100, the network access node 550, or the road side unit 560 using e.g. radio resource control (RRC) signaling or physical layer signaling such as downlink control information (DCI)/sidelink control information (SCI) or medium access control (MAC) control element (CE).

When the reporting subset 300a′, 300b′, . . . , 300n′ is determined by the network access node 550 or the road side unit 560, the network access node 550 or the road side unit 560 may provide information about the determined reporting subset 300a′, 300b, . . . , 300n′ to the first communication device 100 in a configuration. Thus, the first communication device 100 may in embodiments determine the reporting subset 300a′, 300b′, . . . , 300n′ based on a configuration received from the network access node 550 or the road side unit 560.

According to embodiments of the invention the first communication device 100 may further determine the reporting subset 300a′, 300b′, . . . , 300n′ based on one or more received signal qualities received during a time window. In this case, the first communication device 100 may collect the one or more received signal qualities obtained from the set of second communication devices 300a, 300b, . . . , 300n within the time window and determine the reporting subset 300a′, 300b′, . . . , 300n′ to be the second communication devices who provided received signal quality during the time window. In embodiments where the first communication device 100 has obtained the configuration for a reporting subset 300a′, 300b′, . . . , 300n′ from the network access node 550 or the road side unit 560, the first communication device 100 may determine the reporting subset 300a′, 300b′, . . . , 300n′ to be the second communication devices in the reporting subset 300a′, 300b′, . . . , 300n′ who provided received signal quality during the time window. Thus, the first communication device 100 may determine the reporting subset 300a′, 300b′, . . . , 300n′ to be smaller than the reporting subset 300a′, 300b′, . . . , 300n′ configured by the network access node 550 or the road side unit 560. The duration of the time window may be preconfigured, e.g. in the standard, or configured by the first communication device 100 based on information derived or obtained from another device or node.

When the groupcast communication is performed using beams, the first communication device 100 may define the reporting subset 300a′, 300b′, . . . , 300n′ per beam, per beam pair link, or per quasi co-location (QCL) configuration. The reporting subset 300a′, 300b′, . . . , 300n′ may e.g. be defined per beam specific reference signal. A beam aims to cover a subset of the set of second communication devices 300a, 300b, . . . , 300n and within this subset the reporting subset 300a′, 300b′, . . . , 300n′ is further defined to report received signal quality. The received signal quality is in this case hence related to a specific beam. Thus, the groupcast communication may consist of several beams, where a beam may be identified, e.g. based on QCL configuration, and where each beam may be associated with its own reporting subset 300a′, 300b′, . . . , 300n′.

According to embodiments of the invention the first communication device 100 may determine the reporting subset 300a′, 300b′, . . . , 300n′ based on a spatial distance between the first communication device 100 and a second communication device in the set of second communication devices 300a, 300b, . . . , 300n and a required transmission range. For example, the first communication device 100 may determine that only second communication devices 300 which are in proximity to the required transmission range are included in the reporting subset 300a′, 300b′, . . . , 300n′. In this way, the first communication device 100 can obtain received signal qualities from the second communication devices 300 in the set of second communication devices 300a, 300b, . . . , 300n which are close to the boarder of the transmission range, i.e. close to the range that the first communication device 100 is expected to reach/cover with the groupcast transmission. The required transmission range may be a preconfigured range inside which it is important that the groupcast transmission is successful, while outside the range the transmission is “best effort”. The required transmission range may further be referred to as a minimum required communication range. The spatial distance between the first communication device 100 and the second communication device 300 may e.g. be determined based on a location of the second communication device 300 reported to the first communication device 100 in a physical layer signaling, e.g. SCI, or higher layer signaling such as e.g. MAC, RRC, or application layer signaling. The spatial distance may further be obtained from an application such as e.g. an V2X application in the first communication device 100.

The first communication device 100 may further determine the reporting subset 300a′, 300b′, . . . , 300n′ based on a groupcast use case for the reporting subset 300a′, 300b′, . . . , 300n′. In this way, the first communication device 100 can determine to only obtain received signal qualities from second communication devices 300 in a specific groupcast use case. For example, for groupcast in platooning the groupcast use case may be associated with a relative position of the second communication device 300 within the group.

Additional information may be considered by the first communication device 100 when determine the reporting subset 300a′, 300b, . . . , 300n′. The reporting subset 300a′, 300b′, . . . , 300n′ may hence be determined based on additional input parameters. The additional input parameters may e.g. be any one or more of the following parameters:
Group size
Relative position within the group
Direction of the first communication device 100 relative to the second communication device 300, a specific QCL configuration (Beam)
Speed of group or individual speed of each member in the group
Vehicle Type
Antenna Location(s) on the second communication device 300

The network access node 550 or the road side unit 560 may determine the reporting subset 300a′, 300b′, . . . , 300n′ in a similar way as the first communication device 100, i.e. based on the spatial distance between the first communication device 100 and the second communication device in the reporting subset 300a′, 300b′, . . . , 300n′ and the required transmission rang, as well as based on the groupcast use case for the reporting subset 300a′, 300b, . . . , 300n′ and the additional input parameters listed above.

In step 604, the first communication device 100 determines at least one path loss value for the reporting subset 300a′, 300b′, . . . , 300n′ based on the one or more obtained received signal qualities and further determines a transmission power value for the groupcast communication based on the at least one path loss value. In embodiments, the first communication device 100 may determine a single common path loss value for the reporting subset 300a′, 300b′, . . . , 300n′ based on a first function and the received signal qualities. The first function may be the mean, weighted mean, median, minimum or maximum of the received signal qualities for the reporting subset 300a′, 300b, . . . , 300n′. The first communication device 100 then determines the transmission power value based on the single common path loss value.

In embodiments where the received signal qualities are RSRP values, the single common path loss value PL_{subset} may be determined using equation 1, where n is the size of the reporting subset 300a′, 300b′, . . . , 300n′ and g1 is the first function. As described above, if the received signal qualities are unfiltered layer 1 RSRP values, the first communication device 100 may perform layer 3 filtering of the reported unfiltered layer 1 RSRP values and use the filtered RSRP values when determining the single common path loss value PL_{subset}.

PL_{subset}=referenceSignalPower−g1(RSRP{300a′ . . . 300n′}) Equation 1

The determined single common path loss value PL_{subset} may then be used in a transmission power formula to determine the transmission power value for the groupcast communication. The transmission power formula may be based on the transmission power formula according to the 3GPP NR standard and may hence when the groupcast communication transmission is performed in a physical sidelink shared channel (PSSCH), be expressed as:

P_{PSSCH}(i,j,q_{d})=min{P_{cMAX,PSSCH}(i)P_{O_PSSCH}(j)+10 log₁₀(2^{μ}·M_{PSSCH}(i))+α_{PSSCH}(j)·PL_{subset}(q_{d})} Equation 2

A similar transmission power formula may be used when the groupcast communication transmission is performed in a physical sidelink control channel (PSCCH) but with PSCCH specific factors.

In embodiments, the first communication device 100 may in step 604 instead determine a path loss value for each second communication device in the reporting subset 300a′, 300b′, . . . , 300n′ and then determine the transmission power value based on a second function and the path loss values for each second communication device in the reporting subset 300a′, 300b, . . . , 300n′. The second function may be the mean, weighted mean, median, minimum or maximum of the path loss values for each second communication device in the reporting subset 300a′, 300b′, . . . , 300n′.

In embodiments where the received signal quality is an RSRP value, the path loss value PL₃₀₀_{ₓ} for each second communication device in the reporting subset 300a′, 300b′, . . . , 300n′ may be determined using equation 3, where x is 1, 2, . . . , n and n is the size of the reporting subset 300a′, 300b′, . . . , 300n′.

PL₃₀₀_{ₓ},=referenceSignalPower−RSRP₃₀₀_{ₓ} Equation 3

The determined respective path loss value PL₃₀₀_{ₓ} for each second communication device in the reporting subset 300a′, 300b′, . . . , 300n′ may then be used in a transmission power formula to determine the transmission power value for the groupcast communication. The transmission power formula may include the second function g2 which considers the path loss value PL₃₀₀_{ₓ} for each second communication device in the reporting subset 300a′, 300b′, . . . , 300n′, where the second function g2 may be the mean, weighted mean, median, minimum or maximum of the path loss values PL₃₀₀_{ₓ} for each second communication device in the reporting subset 300a′, 300b′, . . . , 300n′. In embodiments where the groupcast communication transmission is performed in the PSSCH and the transmission power formula is based on the transmission power formula according to the 3GPP NR standard, the transmission formula may be expressed as:

P_{PSSCH}(i,j,q_{d})=min{P_{cMAX,PSSCH}(i),P_{O_PSSCH}(j)+10 log₁₀(2^{μ}·M_{PSSCH}(i)+α_{PSSCH}(j)·g2(PL₃₀₀_{₁}_{, . . . ,300}_{ₙ}(q_{d}))} Equation 4

In step 606, the first communication device 100 perform a groupcast communication transmission based on the determined transmission power value. The first communication device 100 may e.g. perform the groupcast communication transmission in the PSCCH or in the PSSCH. By performing the groupcast communication transmission based on the determined transmission power value, the power of the groupcast communication transmission can be effectively adjusted to the path losses experienced by the reporting subset 300a′, 300b′, . . . , 300n′ in the set of second communication devices 300a, 300b, . . . , 300n.

FIG. 7 shows a flow chart of a method 700 for transmitting measured received signal quality according to embodiments of the invention. The method 700 may be performed in the second communication device 300 when configured for groupcast communication with the first communication device 100. In step 702, the second communication device 300 obtains a measurement configuration 520 for the groupcast communication, wherein the measurement configuration 520 indicates at least one reporting condition. The second communication device 300 may obtain the measurement configuration 520 from the first communication device 100, a network access node 550, or a road side unit 560.

In step 704, the second communication device 300 measures received signal quality according to the measurement configuration 520 obtained in step 702. The received signal quality may be at least one of a RSRP, a SNR, and a RSRQ. The second communication device 300 may measure the received signal quality continuously or at predetermined intervals. The second communication device 300 may measure the received signal quality in a conventional way based on e.g. measurement of reference signals received from the first communication device 100.

In step 706, the second communication device 300 monitors the at least one reporting condition indicated in the measurement configuration 520 to determine whether the reporting condition is fulfilled. In embodiments, the reporting condition may be associated with a spatial distance between the first communication device 100 and the second communication device 300. In such embodiments, determine that the reporting condition is fulfilled may comprises determine that the at least one reporting condition is fulfilled if the spatial distance between the first communication device 100 and the second communication device 300 approximately corresponds to a required transmission range. In this way, reporting can be triggered when the second communication device 300 is at a spatial distance from the first communication device 100 which is close to the required transmission range. The required transmission range may be a preconfigured range within which groupcast communication between the first communication device 100 and the second communication device 300 is possible. The spatial distance between the first communication device 100 and the second communication device 300 may e.g. be determined based on the location of the first communication device 100 reported to the second communication device 300 in a physical layer signaling, e.g. SCI, or higher layer signaling such as e.g. MAC, RRC, or application layer signaling. The spatial distance may further be obtained from an application such as e.g. an V2X application in the second communication device 300.

According to embodiments of the invention determine that the at least one reporting condition is fulfilled in step 706 may further comprises determine that a groupcast use case for the second communication device 300 is fulfilled. In this way, reporting can be triggered depending on the group cast use case that the second communication device 300 is operating in. For example, for groupcast in platooning the groupcast use case may be associated with a relative position of the second communication device 300 within the group.

Furthermore, additional information may be considered by the second communication device 300 when determining whether the reporting condition is fulfilled. The reporting condition may hence, in addition to spatial distance and/or groupcast use case, be dependent on additional input information. The additional input parameters may e.g. be any one or more of the following parameters:
Group size
Relative position within the group
Direction of the first communication device 100 relative to the second communication device 300, a specific QCL configuration (Beam)
Speed of group or individual speed of each member in the group
Vehicle Type
Antenna Location(s) on the second communication device 300

Upon determining in step 706 that the at least one reporting condition is fulfilled, the second communication device 300 transmits the measured received signal quality to the first communication device 100 in step 708. The second communication device 300 may e.g. transmit the measured received signal quality in layer 1 physical control signaling or in layer 3 radio resource control signaling. When the at least one reporting condition is not fulfilled, the second communication device 300 continues to measure the received signal quality in step 704 and monitor the at least one reporting condition in step 706.

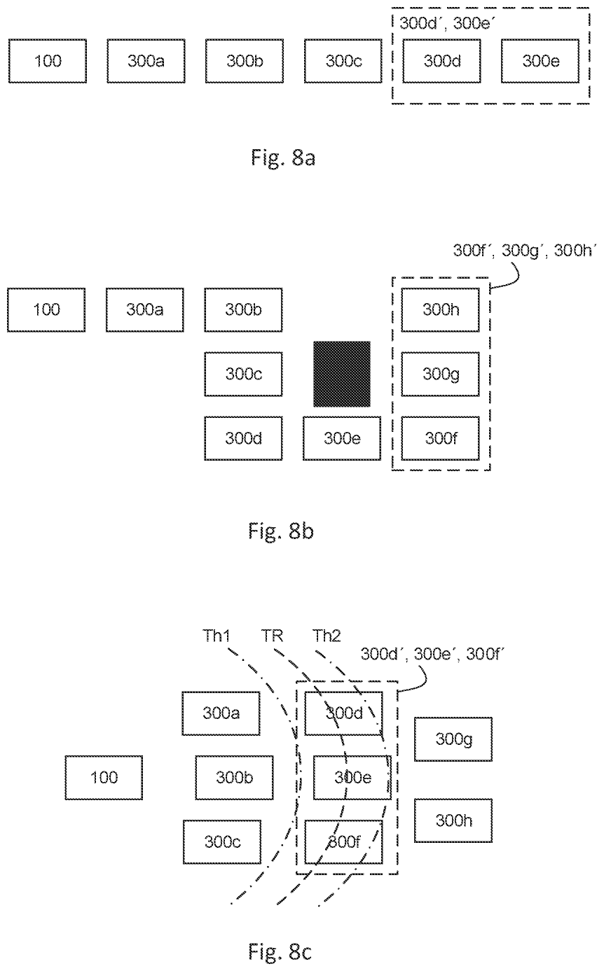

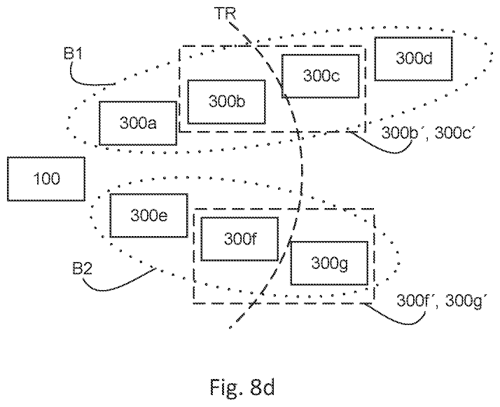

FIGS. 8a-d show reporting subsets 300a′, 300b′, . . . , 300n′ in different group cast scenarios according to embodiments of the invention. FIG. 8a shows a group cast scenario where the set of second communication devices 300a, 300b, 300c, 300d, 300e are lined up after the first communication device 100, the set of second communication devices 300a, 300b, 300c, 300d, 300e may e.g. be a platoon of vehicles controlled by the first communication device 100. In the embodiment shown in FIG. 8a, it is assumed that the first communication device 100 wants to reach all the members of the group when performing groupcast communication, therefore the two last second communication devices 300d, 300e positioned furthest away from the first communication device 100 are included in the reporting subset 300d′, 300e′. Thus, the first communication device 100 receives the received signal qualities of the second communication devices in the set of second communication devices 300a, 300b, 300c, 300d which probably experience the highest path loss. The first communication device 100 can thereby determine the transmission power value and perform groupcast communication based on the determined transmission power such that the groupcast communication will reach all the second communication devices in the set of second communication devices 300a, 300b, 300c, 300d, 300e.

FIG. 8b also shows a group cast scenario where the set of second communication devices 300a, 300b, 300c, 300d, 300e, 300f, 300g, 300h are lined up, e.g. platooning, after the first communication device 100 and where the first communication device 100 wants to reach all the members of the group when performing groupcast communication. In the embodiment shown in FIG. 8b, the last three second communication devices 300f, 300g, 300h has been determined to be the reporting subset 300f′, 300g′, 300h′. The last second communication device 300h in the reporting subset 300f′, 300g′, 300h′ has line-of-sight to the first communication device 100, while the other two second communication devices 300f, 300g within the reporting subset 300f′, 300g′, 300h′ have their reported path loss effected by a building blocking the line-of-sight, as shown in FIG. 8b. In such a situation, the reporting subset 300f′, 300g′, 300h′ allows the path loss to be determined based on the combined information from the last three second communication devices 300f, 300g, 300h and the determined path loss will hence result in a transmission power for the groupcast communication which makes it more likely that the groupcast communication is successful, i.e. reaches all the members of the group.

FIG. 8c shows a group cast scenario where a minimum required transmission range TR is defined for a groupcast communication from the first communication device 100 to the set of second communication devices 300a, 300b, 300c, 300d, 300e, 300f, 300g, 300h. The reporting subset 300d′, 300e′, 300f′ is determined based on the transmission range TR. FIG. 8c further shows two thresholds of a reporting condition Th1, Th2 within which the reporting condition is fulfilled, i.e. any second communication device 300 located between the first threshold of the reporting condition Th1 and the second threshold of the reporting condition Th2 will report received signal quality to the first communication device 100. Outside the transmission range the transmission is best effort and the reporting subset 300d′, 300e′, 300f′ reflect the second communication devices 300 adjacent to the transmission range TR border. The two thresholds of the reporting condition Th1, Th2 have been selected such that the first threshold of the reporting condition Th1 is inside the transmission range TR and the second threshold of the reporting condition Th2 is outside the transmission range TR.

FIG. 8d shows a group cast scenario where a minimum required transmission range TR is defined for a groupcast communication and further where two different beams B1, B2 are used to target subsets of the set of second communication devices 300a, 300b, 300c, 300d, 300e, 300f, 300g. A first beam B1 is used for groupcast communication from the first communication device 100 to a first subset of second communication devices 300a, 300b, 300c, 300d, and a second beam B2 is used for groupcast communication from the first communication device 100 to a second subset of second communication devices 300e, 300f, 300g. FIG. 8d further shows that a reporting subset is defined per beam, i.e. a first reporting subset 300b′, 300c′ for the first beam B1 and a second reporting subset 300f′, 300g′ for the second beam B2. Each reporting subset may be defined based on the transmission range TR. Outside the transmission range TR the transmission is best effort and the first reporting subset 300b′, 300c′ and the second reporting subset 300f′, 300g′ reflect the second communication devices 300 adjacent to the transmission range TR.

The first communication device 100 and/or the second communication device 300 herein, may be denoted as a user device, a User Equipment (UE), a mobile station, an internet of things (IoT) device, a sensor device, a wireless terminal and/or a mobile terminal, is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM). The UE may also be configured for communication in 3GPP related LTE and LTE-Advanced, in WiMAX and its evolution, and in fifth generation wireless technologies, such as New Radio.

However, the first communication device 100 herein may also be denoted as a radio network access node, an access network access node, an access point, or a base station, e.g. a Radio Base Station (RBS), which in some networks may be referred to as transmitter, “gNB”, “gNodeB”, “eNB”, “eNodeB”, “NodeB” or “B node”, depending on the technology and terminology used. The radio network access nodes may be of different classes such as e.g. macro eNodeB, home eNodeB or pico base station, based on transmission power and thereby also cell size. The radio network access node can be a Station (STA), which is any device that contains an IEEE 802.11-conformant Media Access Control (MAC) and Physical Layer (PHY) interface to the Wireless Medium (WM). The radio network access node may also be a base station corresponding to the fifth generation (5G) wireless systems. The first communication device 100 herein may also be denoted as a road side unit such as e.g. a road side unit in a V2X application. The road side unit may be any device/node deployed along roads to improve vehicular network performance, as well as extend the coverage. The road side unit may be a stand-alone device/node or may be integrated with e.g. a network access node.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the first communication device 100 and the second communication device 300 comprises the necessary communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Especially, the processor(s) of the first communication device 100 and the second communication device 300 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A first communication device (100) for a wireless communication system (500), the first communication device (100) being configured for groupcast communication with a set of second communication devices (300a, 300b, . . . , 300n), and further being configured to
obtain one or more received signal qualities from respective one or more second communication devices of a reporting subset (300a′, 300b′, . . . , 300n′) in the set of second communication devices (300a, 300b, . . . , 300n);
determine at least one path loss value for the reporting subset (300a′, 300b′, . . . , 300n′) based on the one or more obtained received signal qualities.

2. The first communication device (100) according to claim 1, wherein the reporting subset (300a′, 300b′, . . . , 300n′) is determined based on a configuration received from a network access node (550) or a road side unit (560).

3. The first communication device (100) according to claim 1, wherein the reporting subset (300a′, 300b′, . . . , 300n′) is determined based on one or more received signal qualities received during a time window.

4. The first communication device (100) according to claim 1, configured to
determine a transmission power value for the groupcast communication based on the at least one path loss value.

5. The first communication device (100) according to claim 4, configured to
perform a groupcast communication transmission based on the determined transmission power value.

6. The first communication device (100) according to claim 5, configured to
perform the groupcast communication transmission in a physical sidelink control channel or in a physical sidelink shared channel.

7. The first communication device (100) according to claim 4, configured to
determine a single common path loss value for the reporting subset (300a′, 300b′, . . . , 300n′) based on a first function and the received signal qualities; and
determine the transmission power value based on the single common path loss value.

8. The first communication device (100) according to claim 4, configured to
determine a path loss value for each second communication device in the reporting subset (300a′, 300b′, . . . , 300n′); and
determine the transmission power value based on a second function and the path loss values for each second communication device in the reporting subset (300a′, 300b′, . . . , 300n′).

9. The first communication device (100) according to claim 7, wherein
the first function is the mean, weighted mean, median, minimum or maximum of the received signal qualities for the reporting subset (300a′, 300b′, . . . , 300n′), and
the second function is the mean, weighted mean, median, minimum or maximum of the path loss values for each second communication device in the reporting subset (300a′, 300b′, . . . , 300n′).

10. The first communication device (100) according to claim 1, configured to
define the reporting subset (300a′, 300b′, . . . , 300n′) per beam, per beam pair link, or per QCL configuration.

11. The first communication device (100) according to claim 1, configured to
determine the reporting subset (300a′, 300b, . . . , 300n′) based on a spatial distance between the first communication device (100) and a second communication device in the reporting subset (300a′, 300b′, . . . , 300n′) and a required transmission range.

12. The first communication device (100) according to claim 11, configured to
determine the reporting subset (300a′, 300b′, . . . , 300n′) further based on a groupcast use case for the reporting subset (300a′, 300b′, . . . , 300n′).

13. The first communication device (100) according to claim 11, configured to
transmit a measurement configuration (520) for the groupcast communication to at least one second communication device (300), wherein the measurement configuration (520) indicates at least one reporting condition.

14. The first communication device (100) according to claim 1, wherein the received signal quality is at least one of:
a reference signal received power,
a signal-to-noise ratio, and
a reference signal received quality.

15. A second communication device (300) for a wireless communication system (500), the second communication device (300) being configured for groupcast communication with a first communication device (100), and further being configured to
obtain a measurement configuration (520) for the groupcast communication, wherein the measurement configuration (520) indicates at least one reporting condition;
measure received signal quality according to the measurement configuration (520); and
transmit the measured received signal quality to the first communication device (100) upon determine that the at least one reporting condition is fulfilled.

16. The second communication device (300) according to claim 15, wherein determine that the reporting condition is fulfilled comprises
determine that the at least one reporting condition is fulfilled if a spatial distance between the first communication device (100) and the second communication device (300) is within a required transmission range.

17. The second communication device (300) according to claim 16, wherein determine that the at least one reporting condition is fulfilled further comprises
determine that a groupcast use case for the second communication device (300) is fulfilled.

18. The second communication device (300) according to claim 15, configured to
obtain the measurement configuration (520) from the first communication device (100), a network access node (550) or a road side unit (560).

19. The second communication device (300) according to claim 15, wherein the received signal quality is at least one of:
a reference signal received power,
a signal-to-noise ratio, and
a reference signal received quality.

20. A method (200) for a first communication device (100) configured for groupcast communication with a set of second communication devices (300a, 300b, . . . , 300n), the method (200) comprising
obtaining (202) one or more received signal qualities from respective one or more second communication devices of a reporting subset (300a′, 300b′, . . . , 300n′) in the set of second communication devices (300a, 300b, . . . , 300n);
determining (204) at least one path loss value for the reporting subset (300a′, 300b′, . . . , 300n′) based on the one or more obtained received signal qualities.
